(19) United States
(12) Patent Application Publication
(10) Pub. No.: US 2018/0152091 A1
(43) Pub. Date: May 31, 2018

(54) Energy Harvester And A System Using The Energy Harvester

(71) Applicant: Alcatel-Lucent Ireland Ltd., Dublin (IE)

(72) Inventors: Brian G. Donnelly, Dublin (IE); James Howard, Kilkee (IE)

(73) Assignee: ALCATEL LUCENT, Boulogne-Billancourt (FR)

(21) Appl. No.: 15/364,799

(22) Filed: Nov. 30, 2016

(51) Int. Cl. H02K 35/02; G01D 11/00

(52) U.S. Cl. CPC H02K 35/02; G01D 11/00

(57) ABSTRACT

An apparatus comprises a membrane having a planar surface enclosed inside a duct structure which has an opening provided at an end thereof. A permanent magnet fixed to the membrane is configured to oscillate in response to a mechanical disturbance caused by a vibrating fluid within the duct structure. The oscillation of the membrane causes the permanent magnet to move inside an electromagnetic coil to thereby induce electric energy in the coil. An energy harvester and a system for monitoring a condition of an object are also disclosed.

### TECHNICAL FIELD

The present invention relates to techniques for harvesting energy and systems using such techniques.

### BACKGROUND

In many circumstances it is necessary to provide electric energy to devices that are installed at remote locations. Herein the term “remote location” is to be understood to relate to locations where either power supply infrastructure does not exist or, if an infrastructure does exist, power is not available at the specific location where the device or equipment is installed. The unavailability of electric energy at the remote location typically implies that devices would need to be powered using electricity provided or generated on site.

### SUMMARY

Some embodiments feature an apparatus, comprising:
a membrane having at least one planar surface;
a duct structure having a wall, the duct structure enclosing the planar surface and having an opening provided at an end thereof;
a permanent magnet attached to the membrane;
an electromagnetic coil;
   wherein the membrane is configured to oscillate in response to a mechanical disturbance caused by a vibrating fluid within the duct structure, said oscillation of the membrane causing the permanent magnet to move inside the electromagnetic coil to thereby induce electric energy in the coil.

In some specific embodiments, the membrane is made of a flexible material.

In some specific embodiments, the membrane is attached at one side thereof to the wall of the duct structure and is configured to oscillate about an axis of oscillation defined by said one side.

In some specific embodiments, the membrane is attached at least at two sides thereof to the wall of the duct structure and is configured to oscillate between a convex and a concave position with said at least two sides being fixed to the wall.

In some specific embodiments, a cross-section of the duct structure is circular and the duct structure has a cylindrical shape.

In some specific embodiments, a cross-section of the duct structure is a polygonal and the duct structure has a prismatic polyhedron shape in conformity with the shape of said cross-section.

In some specific embodiments, the membrane is made of a rigid material and is mounted on a resilient support structure configured to oscillate when the membrane experiences a mechanical disturbance caused by a vibrating fluid within the duct structure.

In some specific embodiments, a perimeter of the at least one planar surface of the membrane has substantially matching shape and dimensions with the cross-section of the duct structure such that fluid is substantially prevented from passing from one side of the membrane to an opposite side of the membrane within the duct structure.

In some specific embodiments, a perimeter of the at least one planar surface of the membrane has at least one portion which is separated from the wall of the duct structure such that fluid is allowed to pass from one side of the membrane to an opposite side of the membrane within the duct structure.

In some specific embodiments, the at least one planar surface of the membrane has holes such that fluid is allowed to pass from one side of the membrane to an opposite side of the membrane within the duct structure.

Some embodiments, feature and energy harvester, comprising:
a membrane having at least one planar surface;
a duct structure having a wall, the duct structure enclosing the planar surface and having an opening provided at an end thereof;
a permanent magnet attached to the membrane;
an electromagnetic coil;
   wherein the membrane is configured to oscillate in response to a mechanical disturbance caused by a vibrating fluid within the duct structure, said oscillation of the membrane causing the permanent magnet to move inside the electromagnetic coil to thereby induce electric energy in the coil.

Some embodiments feature a system for monitoring a condition of an object, comprising an apparatus including:
a membrane having at least one planar surface;
a duct structure having a wall, the duct structure enclosing the planar surface and having an opening provided at an end thereof;
a permanent magnet attached to the membrane;
an electromagnetic coil;
   wherein the membrane is configured to oscillate in response to a mechanical disturbance caused by a vibrating fluid within the duct structure, said oscillation of the membrane causing the permanent magnet to move inside the electromagnetic coil to thereby induce electric energy in the coil; and
a monitoring device configured to operate by using the electric energy from the electromagnetic coil.

### BRIEF DESCRIPTION OF THE DRAWINGS

The embodiments of the disclosure are best understood from the following detailed description, when read with the accompanying FIGUREs. Some features in the figures may be described as, for example, “top,” “bottom,” “vertical” or “lateral” for convenience in referring to those features. Such descriptions do not limit the orientation of such features with respect to the natural horizon or gravity. Various features may not be drawn to scale and may be arbitrarily increased or reduced in size for clarity of discussion. Reference is now made to the following descriptions taken in conjunction with the accompanying drawings, in which:

FIG. 1 is a schematic representation of an example of an apparatus according to some embodiments.

FIG. 2 is a schematic representation of the apparatus of FIG. 1 in operation, according to some embodiments.

FIG. 3 is a schematic representation of an example of an apparatus according to some embodiments.

FIG. 4 is a schematic representation of an example of an apparatus according to some embodiments in which only a membrane and a cut section of a duct structure of the apparatus are shown.

FIG. 5 is a schematic representation of an example of an apparatus according to some embodiments in which only a membrane and a cut section of a duct structure of the apparatus are shown.

### DETAILED DESCRIPTION OF ILLUSTRATIVE EMBODIMENTS

As mentioned above, devices located at remote locations often need to be provided with electric energy provided or generated on the site where the device is installed.

One example of devices installed at remote locations are devices for monitoring the operating conditions of wind turbines, which often are located at remote locations. Wind turbines gradually get their blades worn by wind dispersed particles such as sand and grit, or the like. Therefore, wind turbines typically require remote monitoring. As can be appreciated, it may become quite difficult to predict how quickly the blades of a wind turbine wear due to the effects of the environment thereon. Clearly, environmental conditions change and thus such changes affect the rate of wear. It would therefore be advantageous to predict the eventual wearing of a place and replace the worn blades before a catastrophic failure of the whole turbine can occur.

One solution to help predict failures in the blades of a wind turbine is to mount devices on the blades themselves to monitor the rate of wear and communicate the result of such monitoring to a remote control center so that appropriate actions are taken to avoid the failure of the whole turbine. These devices are of relatively small size as they need to be positioned on the blades of the turbine in order to obtain a reliable measurement. This approach, however, would require that the monitoring device be provided with power to be able to operate. One solution would be to use batteries for this purpose. However, batteries run out of charge and would need to be replaced periodically by new charged batteries or be recharged. It is therefore desirable to provide a solution for generating electricity on the blade of the turbine to power a monitoring device located thereupon.

The provision of electric energy to power sensing or monitoring devices installed at remote locations may also be needed in certain other fields of technology such as the internet of things (IoT). This field encompasses many situations in which numerous monitoring devices are rolled out, often in locations with no access to existing electric power sources or outlets, such as for example at certain locations inside the buildings.

Vibration energy harvesting, as known in the related art, is the process of using vibrations from the environment to drive generators that provide power for use in electric/electronic devices. This technology has certain advantages as it is typically capable of providing power autonomy, at least to some extent, to devices located at remote locations. Such devices may be located in open urban or rural areas or inside buildings and may be used for constructing the so-called “Smart” systems such as “Smart Buildings” and “Smart Cities”.

The present disclosure proposes a solution for generating energy which is harvested based on the vibration of an element with respect to another as will be described in further detail below.

It is known that air flowing over an open or closed pipe causes the air in the pipe to vibrate at a certain frequency. This frequency is known as the fundamental or natural frequency of the pipe. An example of this phenomenon is when air is blown over the open end of a bottle (approximating a pipe open at one end). When this occurs, the air within the bottle vibrates causing an audible note. The fundamental frequency of the generated note depends, as it is also known, on the shape and the volume of the bottle. For example, filling the bottle halfway with a liquid causes a change in frequency of the note. This phenomenon also explains how musical instruments like flutes and clarinets work. A flute is typically a cylindrical tube open at both ends (i.e. an open pipe). A clarinet is typically a cylindrical pipe closed at one end and open at the other. The fundamental frequency of these devices depends on the length of the pipe, the diameter of the pipe and the speed of sound in air.

The present disclosure proposes the use of this phenomenon to generate electric energy from the flow of a fluid, e.g. air, over or in the proximity of structures which may resemble the form of a pipe. Such electric energy may then be used to provide power to a sensing or monitoring device.

FIG. 1 shows a schematic representation of an example of an apparatus 100 suitable for harvesting energy according to some embodiments. The apparatus 100, hereinafter referred to as energy harvester, comprises a flexible membrane (which also may be called diaphragm) 110 having a first surface 113 with planar configuration which is attached at its sides 111 and 112 to respective fixed walls 120. The membrane 110 may be made of any suitable flexible material which is capable of oscillating in response to mechanical disturbances such as vibration of air. The walls 120 define an enclosure at least around the planar surface 113 of the membrane 110 so as to form a structure D in the form of a duct surrounding the membrane 110 and having at least one end 160 open (e.g. the upper end in the figure). The cross-section of the duct structure D may be of any suitable form. As non-limiting examples the cross-section of the duct structure D may be circular in which case the duct structure D would have a cylindrical shape, or said cross-section may be polygonal, e.g. square, rectangular, etc. and the duct structure D would thus have a prismatic polyhedron shape. In all cases it is preferable that the shape of the duct structure D is in conformity with the shape of the planar surface 113 of the membrane 110. It is clearly understood that in case of a cylindrical duct structure P, the lateral side of the cylinder would constitute the wall 120 of the duct structure.

The term “duct”, as used herein, is to be understood to refer to any structure in the form of a tube, pipe, or any other conduit having a structure capable of allowing a fluid to be conducted or conveyed there-through. The cross-section of the duct may be of any suitable form, such as for example circular or polygonal.

Although in the example embodiment shown in FIG. 1 only sides 111 and 112 are shown to be attached to the walls 120, the disclosure is not so limited and the planar surface 113 of the membrane 110 can have a different number of sides attached to the walls 120. For example, the planar surface 113 may be attached only at one end, say 111, to the wall 120 and be sufficiently rigid to stay in its initial position (horizontal in the figure) and oscillate in response to a mechanical disturbance.

The term “side” as used herein with reference to the planar surface 113 of the membrane 110 is to be understood in a broad sense which would constitute any length of the perimeter of the planar surface that defines the membrane. Therefore, if the planar surface 113 of the membrane has a circular shape, then a length of the circumference of the circle would be a side; likewise, if the planar surface 113 of the membrane has a polygonal shape, then a length of one of the lateral edges or the polygon, or an entire lateral edge may be considered as a side within the scope of the present disclosure.

The energy harvester 100 further comprises a permanent magnet 130 fixed to a second surface 114 of the membrane 110. The second surface may be a surface opposite to the first planar surface 113. The permanent magnet 130 may be movably positioned inside, and partially passes through, an electromagnetic coil 140. Alternatively, the permanent magnet 130 may be movably positioned in the vicinity of the electromagnetic coil 140, sufficiently close, such that a movement of the membrane relative to the coil can induce electric energy therein, as will be further described below. The electromagnetic coil 140 is fixed to the body of the energy harvester 100 and has electric terminals 141 and 142. The planar surface 113 of the membrane 110 forms the base of the duct structure D that is open to the air 150 at an opening provided at its end 160.

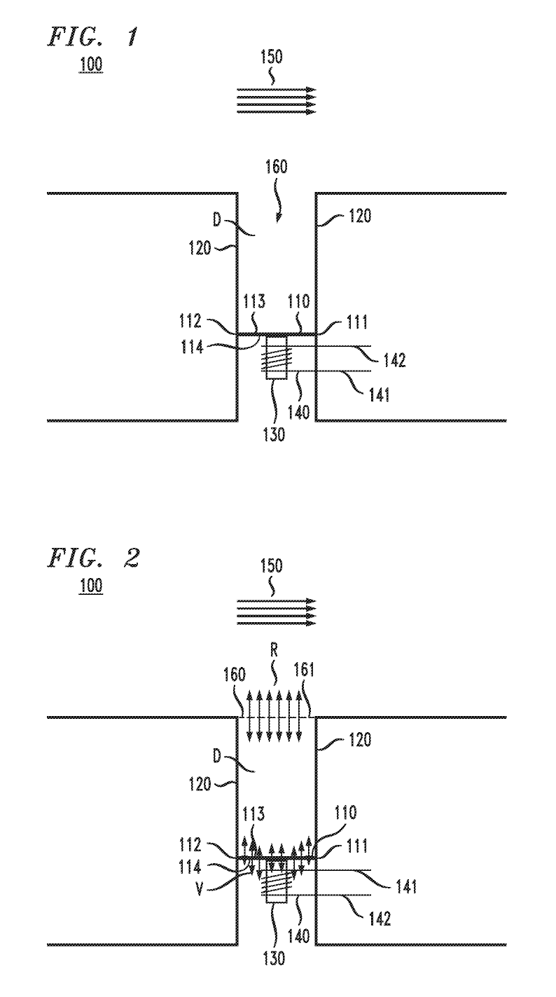

FIG. 2 is a schematic representation of the apparatus 100 of FIG. 1 in operation, according to some embodiments. In FIG. 2, like elements have been provided with like reference numerals as those of FIG. 1.

With reference to FIG. 2, as air 150 flows over and in the vicinity of the open end 160, it causes the air inside the duct structure D to vibrate as it resonates with the movement of the outside air. This is symbolically shown by means of arrows R. This vibration produces a mechanical disturbance which in turn causes the membrane 110 to oscillate as shown in the figure by means of arrows V. The vibration of the membrane 110 causes the permanent magnet 130 to move inside the coil 140 with an oscillating (bidirectional) movement essentially in the same direction of arrows V. This oscillating movement of the magnet 130 relative to the coil 140 gives rise to generating electricity by induction within the coil 140 which becomes available at terminal 141 and 142 of the coil 140.

The oscillation of the membrane 110 may be obtained in various ways. In some embodiments, in which the membrane 110 is fixedly attached at only one side of the planar surface 113, say 111, to the wall 120, the oscillation of the membrane 110 may be produced about an axis of oscillation defined by the attached one side 111, similar to a cantilever oscillating about a fixed axis. In some alternative embodiments, the membrane 110 may be attached at least at two sides 111, 112 of the planar surface 113, to the wall(s) 120 of the duct P. In this case, the membrane 110 may to oscillate between alternate convex and concave positions with the at least two sides 111, 112 staying fixed to the walls 120.

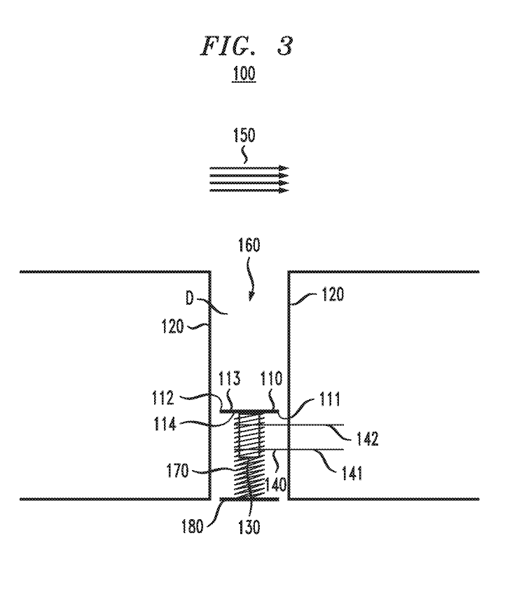

In some embodiments (not explicitly shown in the figures) the membrane is not attached to the wall of the duct structure and may be freely suspended and capable of oscillating in response to a mechanical disturbance caused by the fluid within the duct structure. FIG. 3 illustrates an example of such configuration. In FIG. 3 like elements have been provided with like reference numerals as those of FIG. 1. As seen in FIG. 3, the membrane 110 is not attached to the wall 120 and is mounted on a support structure 170 with resilient properties, such as for example a spring. The support structure 170 is in turn anchored to any suitable part of the duct structure D. In the example of FIG. 3, the support structure 170 is anchored to a platform 180 inside the duct structure D. In these embodiments, the membrane may be made of a rigid material. In this manner, the membrane can oscillate in a similar manner as described with reference to FIG. 2, however with the difference that the mechanical disturbance caused by the fluid within the duct structure imposed on the membrane 110 is transferred from the membrane to the resilient support structure 170 causing the latter to oscillate.

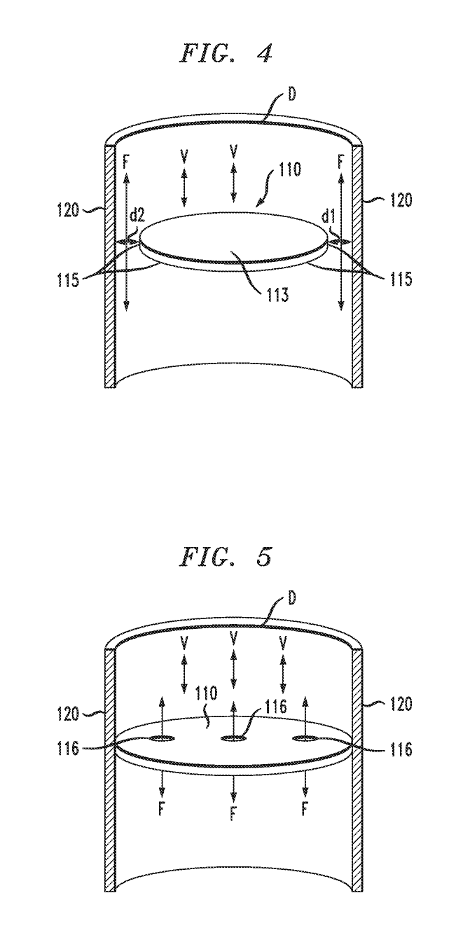

In some embodiments where the membrane is not attached to the wall, at least one portion of the planar surface of the membrane may be separated from the wall of the duct structure to allow air to pass from one side of the membrane to the opposite side of the membrane within the duct structure. A simplified representation of an example of this embodiment is shown in FIG. 4 in which only the membrane 110 and a cut section of the duct structure D are shown. It is assumed that the membrane is capable of oscillating in the direction of double-headed arrows V. It is further assumed that the membrane 110 is mounted on a support structure (not shown) which may for example be a spring located under the membrane and anchored to any suitable location of the duct structure D.

As can be seen in FIG. 4, the perimeter 115 of the membrane 110 is at a distance from the wall 120 of the duct structure D. As this distance may vary from one location to another as one moves around the perimeter of the planar surface 113, it is represented by d1 and d2, where d1 and d2 may be equal or they may be different. Those of ordinary skill in the art will appreciate that many different distances, i.e. d1 to dn, may exist at different location between the perimeter 115 of the planar surface 113 of the membrane 110 and the wall (or walls) 120.

In this manner, when the membrane oscillates in the direction of double-headed arrows V, the fluid, e.g. air, may pass through the separations d1-dn from one side of the membrane 110 to another side as shown by the double-headed arrows F.

In some embodiments where the membrane may or may not be attached to the wall, the membrane may have through-holes.

A simplified representation of an example of this embodiment is shown in FIG. 5 in which only the membrane 110 and a cut section of the duct structure D are shown. In FIG. 5, like elements have been provided by like reference numerals.

It is assumed that the membrane is capable of oscillating in the direction of double-headed arrows V. It is further assumed that the membrane 110 is mounted on a support structure (not shown) which may for example be a spring located under the membrane and anchored to any suitable location of the duct structure D.

As can be seen in FIG. 5, the membrane 110 has a number of holes 116. These holes 116 pass through the body of the membrane 110. In this configuration, when the membrane oscillates in the direction of double-headed arrows V, the fluid, e.g. air, may pass through the holes 116 from one side of the membrane 110 to another side as shown by the double-headed arrows F.

In the embodiments mentioned above with reference to FIGS. 4 and 5, i.e. membrane having a separation from the wall or membrane having through hole, the passage of fluid from one side of the membrane to another may be useful in applications where the amplitude of oscillation of the membrane during operation does not need to be as high as in a device where the membrane does not have such separation or holes. Such passage of fluid from one side of the membrane to another may also result in reduced deflection of the membrane as it reduces the applied force and it may also change the operating frequency as it changes the manner in which the fluid resonates in the duct.

It is to be noted that, due to the structure of the device and the manner it operates, the direction of flow of the air 150 over and in the vicinity of the opening 160 (and not substantially entering the opening) does not matter as long as the air moves substantially parallel to the plane 161 of the opening 160. Therefore, the energy harvester 100 does not need to be mechanically turned into the direction of the wind.

The energy harvester as proposed herein also has the capability of being tuned, to cater for a wide range of wind speeds. Such tuning may be achieved, for example, by selecting appropriate sizes for the length and diameter of the duct structure D.

As already mentioned above, the energy harvester 100 may be mounted on the blade of a wind turbine to generate power locally for devices on the blade. Such devices may include functionalities such as blade condition monitoring, air flow velocity measurement, stall indicators and the like. As the direction of the flow of the air 150 (as long as it moves substantially parallel to the plane 161 of the opening 160) is irrelevant for the operation of the energy harvester, the device can suit a location on a wind turbine blade as it rotates and wind directions change.

Other applications of the proposed energy harvester may be in buildings, in particular the so-called “smart buildings” in which monitoring certain conditions within the building may be necessary and such monitoring is performed at remote locations inside the building. For example, the proposed energy harvester can be installed at the exit of an air duct to extract useful energy from the airflow and provide sufficient electrical power to operate any desired device.

Furthermore, although air has been described as the fluid to produce oscillation in the membrane, the disclosure is not limited as the proposed solution would also be usable in cases where, depending on the circumstance, the fluid is not air. For example, the fluid can be water flowing in the vicinity of an electronic device installed undersea or on an immersed part of a vessel. Therefore, in general, the proposed solution can be used in all cases where there is a fluid moving over an opening of a duct structure. This could have applications in aircraft, marine or civil engineering.

The proposed energy harvester may be structured in a semi-solid state in which the membrane can stretch allowing the magnet to move, with no or negligible friction in the moving surfaces. This ensures high reliability and ease of manufacture (most energy generating devices have rotating components that will eventually wear).

The energy harvester as disclosed herein may be used in a system for monitoring a condition of an object, such conditions being the state of health or damage of the object to predict and avoid failures in the operation of the object. As non-limiting examples, the object may be any component, device, equipment, tool or parts thereof which may require sensing and/or monitoring. Such systems may thus further include a sensing and/or monitoring device configured to use electric energy generated by the energy harvester as disclosed herein.

The various embodiments of the present disclosure may be combined as long as such combination is compatible and/or complimentary.

Further it is to be noted that the list of structures corresponding to the claimed means is not exhaustive and that one skilled in the art understands that equivalent structures can be substituted for the recited structure without departing from the scope of the invention.

What is claimed is:

1. An apparatus, comprising:
a membrane having at least one planar surface;
a duct structure having a wall, the duct structure enclosing the planar surface and having an opening provided at an end thereof;
a permanent magnet attached to the membrane;
an electromagnetic coil;
wherein the membrane is configured to oscillate in response to a mechanical disturbance caused by a vibrating fluid within the duct structure, said oscillation of the membrane causing the permanent magnet to move inside the electromagnetic coil to thereby induce electric energy in the coil.

2. The apparatus of claim 1, wherein the membrane is made of a flexible material.

3. The apparatus of claim 1, wherein the membrane is attached at one side thereof to the wall of the duct structure and is configured to oscillate about an axis of oscillation defined by said one side.

4. The apparatus of claim 2, wherein the membrane is attached at least at two sides thereof to the wall of the duct structure and is configured to oscillate between a convex and a concave position with said at least two sides being fixed to the wall.

5. The apparatus of claim 1, wherein a cross-section of the duct structure is circular and the duct structure has a cylindrical shape.

6. The apparatus of claim 1, wherein, a cross-section of the duct structure is a polygonal and the duct structure D has a prismatic polyhedron shape in conformity with the shape of said cross-section.

7. The apparatus of claim 1, wherein the membrane is made of a rigid material and is mounted on a resilient support structure configured to oscillate when the membrane experiences a mechanical disturbance caused by a vibrating fluid within the duct structure.

8. The apparatus of claim 1, wherein a perimeter of the at least one planar surface of the membrane has substantially matching shape and dimensions with the cross-section of the duct structure such that fluid is substantially prevented from passing from one side of the membrane to an opposite side of the membrane within the duct structure.

9. The apparatus of claim 1, wherein a perimeter of the at least one planar surface of the membrane has at least one portion which is separated from the wall of the duct structure such that fluid is allowed to pass from one side of the membrane to an opposite side of the membrane within the duct structure.

10. The apparatus of claim 1, wherein the at least one planar surface of the membrane has holes such that fluid is allowed to pass from one side of the membrane to an opposite side of the membrane within the duct structure.

11. An energy harvester, comprising:
a membrane having at least one planar surface;
a duct structure having a wall, the duct structure enclosing the planar surface and having an opening provided at an end thereof;
a permanent magnet attached to the membrane;
an electromagnetic coil;
wherein the membrane is configured to oscillate in response to a mechanical disturbance caused by a vibrating fluid within the duct structure, said oscillation of the membrane causing the permanent magnet to move inside the electromagnetic coil to thereby induce electric energy in the coil.

12. A system for monitoring a condition of an object, comprising an apparatus including:
a membrane having at least one planar surface;
a duct structure having a wall, the duct structure enclosing the planar surface and having an opening provided at an end thereof;
a permanent magnet attached to the membrane;
an electromagnetic coil;
wherein the membrane is configured to oscillate in response to a mechanical disturbance caused by a vibrating fluid within the duct structure, said oscillation of the membrane causing the permanent magnet to move inside the electromagnetic coil to thereby induce electric energy in the coil; and
a monitoring device configured to operate by using the electric energy from the electromagnetic coil.
